(19) United States
(12) Patent Application Publication
(10) Pub. No.: US 2017/0236638 A1
(43) Pub. Date: Aug. 17, 2017

(54) WIRELESS POWER TRANSFER ANTENNA HAVING AUXILIARY WINDING

(71) Applicant: QUALCOMM Incorporated, San Diego, CA (US)

(72) Inventor: Gabriel Isaac Mayo, North Potomac, MD (US)

(21) Appl. No.: 15/043,654

(22) Filed: Feb. 15, 2016

(51) Int. Cl. H01F 38/14; H01Q 1/52; H02J 50/10; H01Q 7/00

(52) U.S. Cl. CPC H01F 38/14; H01Q 7/00; H01Q 1/526; H02J 50/10

(57) ABSTRACT

A wireless power transfer antenna includes a primary antenna portion configured to develop a primary electric field (E-field) and a primary magnetic field (B-field), and an auxiliary winding coupled to the primary antenna portion by the B-field, the auxiliary winding configured to develop an auxiliary electric field (E-field) that combines with the primary E-field resulting in a net E-field that has a magnitude that is smaller than a magnitude of the primary E-field.

### FIELD

The present disclosure relates generally to wireless power. More specifically, the disclosure is directed to a wireless power transfer antenna having an auxiliary winding.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections that require cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices may overcome some of the deficiencies of wired charging solutions. As such, wireless charging systems and methods that efficiently and safely transfer power for charging rechargeable electronic devices are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a wireless power transfer antenna includes a primary antenna portion configured to develop a primary electric field (E-field) and a primary magnetic field (B-field), and an auxiliary winding coupled to the primary antenna portion by the B-field, the auxiliary winding configured to develop an auxiliary electric field (E-field) that combines with the primary E-field resulting in a net E-field that has a magnitude that is smaller than a magnitude of the primary E-field.

Another aspect of the disclosure provides an antenna structure including a primary antenna portion configured to develop a primary electric field (E-field) and a primary magnetic field (B-field), and an auxiliary winding coupled to the primary antenna portion by the B-field, the auxiliary winding configured to develop an auxiliary electric field (E-field) that combines with the primary E-field, thereby reducing a net electric (E)-field in the antenna structure, and thereby reducing a common-mode signal in the antenna structure.

Another aspect of the disclosure provides a method for wireless power transfer including generating a primary electric field (E-field) and a primary magnetic field (B-field) configured to wirelessly transfer power from a transmitter to a receiver, and generating an auxiliary electric field (E-field) based on the primary B-field, the auxiliary e-field combining with the primary E-field such that a net E-field comprising the primary E-field and the auxiliary E-field has a magnitude that is smaller than a magnitude of the primary E-field.

Another aspect of the disclosure provides a device for wireless power transfer including means for generating a primary electric field (E-field) and a primary magnetic field (B-field) configured to wirelessly transfer power from a transmitter to a receiver, and means for generating an auxiliary electric field (E-field) based on the primary B-field, the auxiliary e-field combining with the primary E-field such that a net E-field comprising the primary E-field and the auxiliary E-field has a magnitude that is smaller than a magnitude of the primary E-field.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a functional block diagram of an exemplary wireless power transfer system, in accordance with exemplary embodiments of the invention.

FIG. 2 is a functional block diagram of exemplary components that may be used in the wireless power transfer system of FIG. 1, in accordance with various exemplary embodiments of the invention.

FIG. 3 is a schematic diagram of a portion of transmit circuitry or receive circuitry of FIG. 2 including a transmit or receive antenna, in accordance with exemplary embodiments of the invention.

FIG. 4 is a functional block diagram of a transmitter that may be used in the wireless power transfer system of FIG. 1, in accordance with exemplary embodiments of the invention.

FIG. 5 is a functional block diagram of a receiver that may be used in the wireless power transfer system of FIG. 1, in accordance with exemplary embodiments of the invention.

FIG. 6 is a schematic diagram of a portion of transmit circuitry that may be used in the transmit circuitry of FIG. 4.

FIG. 7 is a simplified diagram illustrating an exemplary embodiment of an antenna structure that can be used in a wireless power transfer system.

FIG. 8 is a cross-sectional diagram illustrating an exemplary embodiment of an antenna structure that can be used in a wireless power transfer system.

FIG. 9 is a cross-sectional diagram illustrating an exemplary embodiment of an antenna structure that can be used in a wireless power transfer system.

FIG. 10 is a cross-sectional diagram illustrating an exemplary embodiment of an antenna structure that can be used in a wireless power transfer system.

FIG. 11 is a cross-sectional diagram illustrating an exemplary embodiment of an antenna structure that can be used in a wireless power transfer system.

FIG. 12 is a simplified diagram illustrating an exemplary alternative embodiment of a multi-layer antenna structure that can be used in a wireless power transfer system.

FIG. 13A is a graphical illustration showing exemplary electromotive force (EMF) generated in an exemplary primary antenna portion and an exemplary auxiliary winding described herein.

FIG. 13B is a graphical illustration showing an exemplary embodiment of the effect that an auxiliary winding has on the projected E-field of a primary antenna portion of FIG. 13A.

FIG. 14 is a flowchart illustrating an exemplary embodiment of a method for wireless power transfer.

FIG. 15 is a functional block diagram of an apparatus for wireless power transfer.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. In some instances, some devices are shown in block diagram form.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving antenna” to achieve power transfer.

Devices that use wireless power transfer are becoming smaller and smaller. As these devices become smaller, it is desirable to reduce the size of the electronic circuits inside of the device. For example, one way of reducing the size of a device that can use wireless power transfer is to convert the electronics from an electrically balanced (also referred to as “differential”) configuration or structure to an electrically unbalanced (also referred to as a single-ended) configuration or structure. For example, converting a wireless power transmitter or wireless power receiver from one having a balanced circuit to one having a single-ended circuit reduces the overall size of the circuit, but may give rise to increased levels of electro-magnetic interference (EMI) emanating from the wireless power transmit antenna or the wireless power receiver antenna. The increased EMI results from converting the antenna from an electrically balanced configuration (one in which two signals having opposite polarity are connected to opposite ends of the antenna and the electric and geometric center of the antenna may or may not be grounded) to a single-ended configuration (one in which one end of the antenna is grounded and a single signal is present at the opposite end, resulting in a higher common mode signal at the antenna). Wireless power transfer EMI compliance poses a significant challenge in terms of managing common mode signals at a wireless power transfer antenna. The antenna is electrically exposed to free space and the common mode component of the input signal projects displacement currents in the antenna that can result in high levels of EMI.

A prior approach to reducing common mode signals, and improving common mode rejection, is to interface to the wireless power transmit antenna with balanced electronics and to construct the antenna in symmetrical fashion, achieving electrical and geometric balance, which results in high common mode rejection. However, it is desirable to provide the electronics with a single-ended configuration to reduce the size and cost of the electronic circuits inside of the device. Unfortunately, single-ended circuitry generally gives rise to elevated levels of EMI as a result of a common-mode voltage signal generated by the single-ended circuitry. The common-mode voltage signal gives rise to elevated levels of common-mode noise at the wireless power antenna.

It is also generally cost effective to fabricate a wireless power transfer antenna as a single-ended structure, typically formed as a single layer spiral on a printed circuit board. Unfortunately, such a single-ended structure is inherently electrically unbalanced for at least the reasons mentioned above.

A prior solution uses a symmetrically wound antenna, but this solution typically requires at least a two-layer printed circuit board and multiple lines having signal crossings, thus increasing manufacturing complexity and cost.

The disclosure describes a wireless power transfer antenna having an auxiliary winding. In an exemplary embodiment, the auxiliary winding can be part of a wireless power transmit antenna or a wireless power receiver antenna. In an exemplary embodiment, the auxiliary winding will be described herein in the context of a wireless power receiver antenna. In an exemplary embodiment, the auxiliary winding can at least partially balance the electric field (E-field) of the wireless power transfer antenna and minimize a common-mode signal in the antenna. The auxiliary winding can extend from the end of the wireless power transfer antenna at which the source signal is applied or taken, or can extend from the end of the wireless power transfer antenna that is coupled to ground. Alternatively, the auxiliary winding can take the form of a single or multi-element shield that can be formed in the vicinity of the wireless power transfer antenna. In an exemplary embodiment, the wireless power transfer antenna structure induces a primary voltage in a primary antenna portion that induces a primary electric field (E-field) and a primary magnetic field (B-field) via a magnetic coupling, and induces an auxiliary voltage in the auxiliary winding. The voltage induced in the auxiliary winding generates an electric (E) field that, when combined with the electric (E) field induced in the primary antenna portion of the wireless power transfer antenna, reduces the net electric (E)-field in the wireless power transfer antenna structure, thereby reducing the common-mode signal in the wireless power transfer antenna structure.

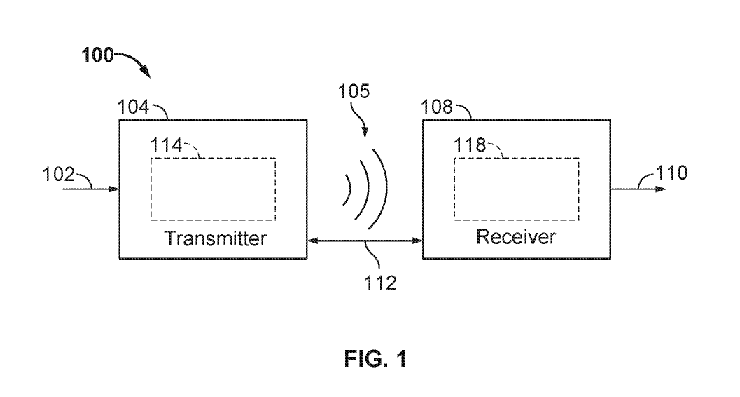

FIG. 1 is a functional block diagram of an exemplary wireless power transfer system 100, in accordance with exemplary embodiments of the invention. Input power 102 may be provided to a transmitter 104 from a power source (not shown) for generating a field 105 (e.g., magnetic or species of electromagnetic) for providing energy transfer. A receiver 108 may couple to the field 105 and generate output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship. When the resonant frequency of receiver 108 and the resonant frequency of transmitter 104 are substantially the same or very close, transmission losses between the transmitter 104 and the receiver 108 are reduced. As such, wireless power transfer may be provided over larger distances in contrast to purely inductive solutions that may require large coils to be very close (e.g., millimeters). Resonant inductive coupling techniques may thus allow for improved efficiency and power transfer over various distances and with a variety of inductive coil configurations.

The receiver 108 may receive power when the receiver 108 is located in a magnetic field 105 produced by the transmitter 104. The field 105 corresponds to a region where energy output by the transmitter 104 may be captured by a receiver 108. The transmitter 104 may include a transmit antenna 114 (that may also be referred to herein as a coil) for outputting an energy transmission. The receiver 108 further includes a receive antenna 118 (that may also be referred to herein as a coil) for receiving or capturing energy from the energy transmission. The near-field may correspond to a region in which there are strong reactive fields resulting from the currents and charges in the transmit antenna 114 that minimally radiate power away from the transmit antenna 114. In some cases the near-field may correspond to a region that is within about one wavelength (or a fraction thereof) of the transmit antenna 114.

In accordance with the above therefore, in accordance with more particular embodiments, the transmitter 104 may be configured to output a time varying magnetic field 105 with a frequency corresponding to the resonant frequency of the transmit antenna 114. When the receiver is within the field 105, the time varying magnetic field 105 may induce a voltage in the receive antenna 118 that causes an electrical current to flow through the receive antenna 118. As described above, if the receive antenna 118 is configured to be resonant at the frequency of the transmit antenna 114, energy may be more efficiently transferred. The AC signal induced in the receive antenna 118 may be rectified as described above to produce a DC signal that may be provided to charge or to power a load.

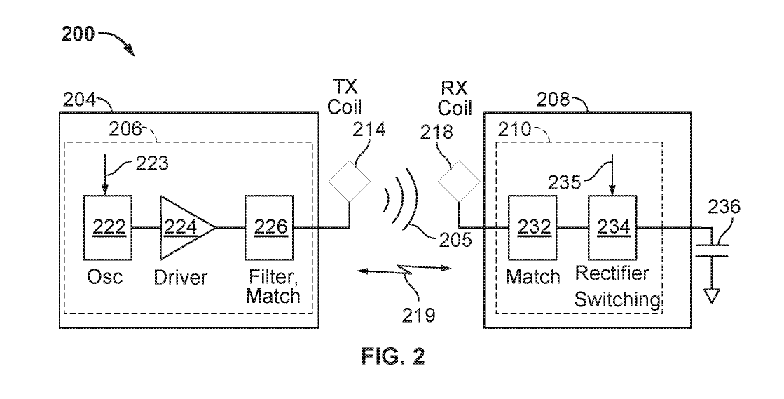

FIG. 2 is a functional block diagram of a wireless power transfer system 200 that includes exemplary components that may be used in the wireless power transfer system 100 of FIG. 1, in accordance with various exemplary embodiments of the invention. The transmitter 204 may include transmit circuitry 206 that may include an oscillator 222, a driver circuit 224, and a filter and matching circuit 226. The oscillator 222 may be configured to generate a signal at a desired frequency, such as 468.75 KHz, 6.78 MHz or 13.56 MHz, that may be adjusted in response to a frequency control signal 223. The oscillator signal may be provided to a driver circuit 224 configured to drive the transmit antenna 214 at, for example, a resonant frequency of the transmit antenna 214. The driver circuit 224 may be a switching amplifier configured to receive a square wave from the oscillator 222 and output a sine wave. For example, the driver circuit 224 may be a class E amplifier. A filter and matching circuit 226 may be also included to filter out harmonics or other unwanted frequencies and match the impedance of the transmitter 204 to the impedance of the transmit antenna 214. As a result of driving the transmit antenna 214, the transmitter 204 may wirelessly output power at a level sufficient for charging or powering an electronic device. As one example, the power provided may be for example on the order of 300 milliWatts to 5 Watts or 5 Watts to 40 Watts to power or charge different devices with different power requirements. Higher or lower power levels may also be provided.

The receiver 208 may include receive circuitry 210 that may include a matching circuit 232 and a rectifier and switching circuit 234 to generate a DC power output from an AC power input to charge a battery 236 as shown in FIG. 2 or to power a device (not shown) coupled to the receiver 208. The matching circuit 232 may be included to match the impedance of the receive circuitry 210 to the impedance of the receive antenna 218. The receiver 208 and transmitter 204 may additionally communicate on a separate communication channel 219 (e.g., Bluetooth, zigbee, cellular, etc.). The receiver 208 and transmitter 204 may alternatively communicate via in-band signaling using characteristics of the wireless field 205.

The receiver 208 may initially have a selectively disablable associated load (e.g., battery 236), and may be configured to determine whether an amount of power transmitted by transmitter 204 and received by receiver 208 is appropriate for charging a battery 236. Further, receiver 208 may be configured to enable a load (e.g., battery 236) upon determining that the amount of power is appropriate.

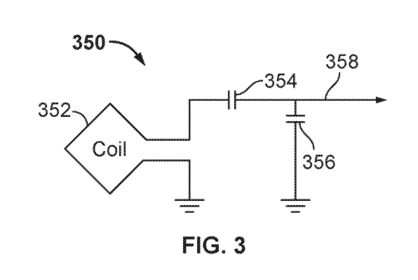

FIG. 3 is a schematic diagram of a portion of transmit circuitry 206 or receive circuitry 210 of FIG. 2 including a transmit or receive antenna 352, in accordance with exemplary embodiments of the invention. As illustrated in FIG. 3, transmit or receive circuitry 350 used in exemplary embodiments including those described below may include an antenna 352. The antenna 352 may also be referred to or be configured as a “loop” antenna 352. The antenna 352 may also be referred to herein or be configured as a “magnetic” antenna or an induction coil. The term “antenna” generally refers to a component that may wirelessly output or receive energy for coupling to another “antenna.” The antenna 352 may also be referred to as a coil of a type that is configured to wirelessly output or receive power. As used herein, an antenna 352 is an example of a “power transfer component” of a type that is configured to wirelessly output and/or receive power. The antenna 352 may be configured to include an air core or a physical core such as a ferrite core (not shown).

The antenna 352 may form a portion of a resonant circuit configured to resonate at a resonant frequency. The resonant frequency of the loop or magnetic antenna 352 is based on the inductance and capacitance. Inductance may be simply the inductance created by the antenna 352, whereas, capacitance may be added to create a resonant structure (e.g., a capacitor may be electrically connected to the antenna 352 in series or in parallel) at a desired resonant frequency. As a non-limiting example, capacitor 354 and capacitor 356 may be added to the transmit or receive circuitry 350 to create a resonant circuit that resonates at a desired frequency of operation. For larger diameter antennas, the size of capacitance needed to sustain resonance may decrease as the diameter or inductance of the loop increases. As the diameter of the antenna increases, the efficient energy transfer area of the near-field may increase. Other resonant circuits formed using other components are also possible. As another non-limiting example, a capacitor (not shown) may be placed in parallel between the two terminals of the antenna 352. For transmit antennas, a signal 358 with a frequency that substantially corresponds to the resonant frequency of the antenna 352 may be an input to the antenna 352. For receive antennas, the signal 358 may be the output that may be rectified and used to power or charge a load.

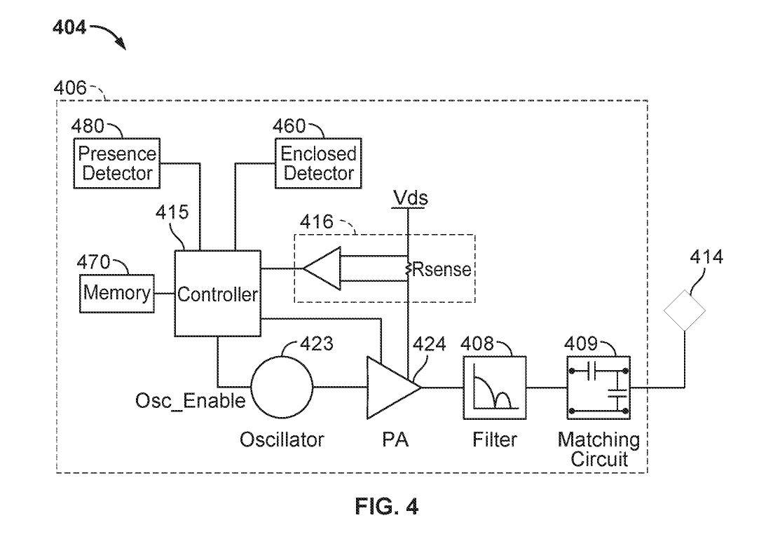

FIG. 4 is a functional block diagram of a transmitter 404 that may be used in the wireless power transfer system of FIG. 1, in accordance with exemplary embodiments of the invention. The transmitter 404 may include transmit circuitry 406 and a transmit antenna 414. The transmit antenna 414 may be the antenna 352 as shown in FIG. 3. The transmit antenna 414 may be configured as the transmit antenna 214 as described above in reference to FIG. 2. In some implementations, the transmit antenna 414 may be a coil (e.g., an induction coil). In some implementations, the transmit antenna 414 may be associated with a larger structure, such as a pad, table, mat, lamp, or other stationary configuration. Transmit circuitry 406 may provide power to the transmit antenna 414 by providing an oscillating signal resulting in generation of energy (e.g., magnetic flux) about the transmit antenna 414. Transmitter 404 may operate at any suitable frequency. By way of example, transmitter 404 may operate at the 6.78 MHz ISM band.

Transmit circuitry 406 may include a fixed impedance matching circuit 409 for matching the impedance of the transmit circuitry 406 (e.g., 50 ohms) to the impedance of the transmit antenna 414 and a low pass filter (LPF) 408 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that may be varied based on measurable transmit metrics, such as output power to the antenna 414 or DC current drawn by the driver circuit 424. Transmit circuitry 406 further includes a driver circuit 424 configured to drive a signal as determined by an oscillator 423. The transmit circuitry 406 may be comprised of discrete devices or circuits, or alternately, may be comprised of an integrated assembly.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as a processor. The controller may be coupled to a memory 470. Adjustment of oscillator phase and related circuitry in the transmission path may allow for reduction of out of band emissions, especially when transitioning from one frequency to another.

The transmit circuitry 406 may further include a load sensing circuit 416 for detecting the presence or absence of active receivers in the vicinity of the near-field generated by transmit antenna 414. By way of example, a load sensing circuit 416 monitors the current flowing to the driver circuit 424, that may be affected by the presence or absence of active receivers in the vicinity of the field generated by transmit antenna 414 as will be further described below. Detection of changes to the loading on the driver circuit 424 are monitored by controller 415 for use in determining whether to enable the oscillator 423 for transmitting energy and to communicate with an active receiver. The transmit antenna 414 may be implemented with a Litz wire or as an antenna strip with the thickness, width and metal type selected to keep resistive losses low.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the driver circuit 424 in response to presence signals from the presence detector 480 and the enclosed detector 460. The transmitter 404 may receive power through a number of power sources, such as, for example, an AC-DC converter (not shown) to convert AC power present in a building, a DC-DC converter (not shown) to convert a DC power source to a voltage suitable for the transmitter 404, or directly from a DC power source (not shown).

As a non-limiting example, the presence detector 480 may be a motion detector utilized to sense the initial presence of a device to be charged that is inserted into the coverage area of the transmitter 404. After detection, the transmitter 404 may be turned on and the power received by the device may be used to toggle a switch on the receiver device in a pre-determined manner, which in turn results in changes to the driving point impedance of the transmitter 404.

As another non-limiting example, the presence detector 480 may be a detector capable of detecting a human, for example, by infrared detection, motion detection, or other suitable means. In some exemplary embodiments, there may be regulations limiting the amount of power that a transmit antenna 414 may transmit at a specific frequency. In some cases, these regulations are meant to protect humans from electromagnetic radiation. However, there may be environments where a transmit antenna 414 is placed in areas not occupied by humans, or occupied infrequently by humans, such as, for example, garages, factory floors, shops, and the like. If these environments are free from humans, it may be permissible to increase the power output of the transmit antenna 414 above the normal power restrictions regulations. In other words, the controller 415 may adjust the power output of the transmit antenna 414 to a regulatory level or lower in response to human presence and adjust the power output of the transmit antenna 414 to a level above the regulatory level when a human is outside a regulatory distance from the wireless charging field of the transmit antenna 414.

As a non-limiting example, the enclosed detector 460 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 404 does not remain on indefinitely may be used. In this case, the transmitter 404 may be programmed to shut off after a user-determined amount of time. This feature prevents the transmitter 404, notably the driver circuit 424, from running long after the wireless devices in its perimeter are fully charged. This event may be due to the failure of the circuit to detect the signal sent from either the repeater or the receive antenna 218 that a device is fully charged. To prevent the transmitter 404 from automatically shutting down if another device is placed in its perimeter, the transmitter 404 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

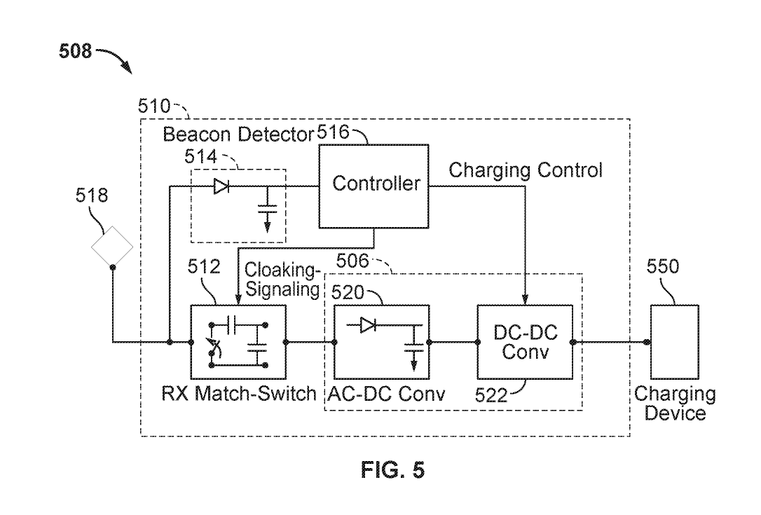

FIG. 5 is a functional block diagram of a receiver 508 that may be used in the wireless power transfer system of FIG. 1, in accordance with exemplary embodiments of the invention. The receiver 508 includes receive circuitry 510 that may include a receive antenna 518. Receiver 508 further couples to device 550 for providing received power thereto. It should be noted that receiver 508 is illustrated as being external to device 550 but may be integrated into device 550. Energy may be propagated wirelessly to receive antenna 518 and then coupled through the rest of the receive circuitry 510 to device 550. By way of example, the charging device may include devices such as mobile phones, portable music players, laptop computers, tablet computers, computer peripheral devices, communication devices (e.g., Bluetooth devices), digital cameras, hearing aids (and other medical devices), wearable devices, and the like.

Receive antenna 518 may be tuned to resonate at the same frequency, or within a specified range of frequencies, as transmit antenna 414 (FIG. 4). Receive antenna 518 may be similarly dimensioned with transmit antenna 414 or may be differently sized based upon the dimensions of the associated device 550. By way of example, device 550 may be a portable electronic device having diametric or length dimension smaller than the diameter or length of transmit antenna 414. In such an example, receive antenna 518 may be implemented as a multi-turn coil in order to reduce the capacitance value of a tuning capacitor (not shown) and increase the receive coil's impedance. By way of example, receive antenna 518 may be placed around the substantial circumference of device 550 in order to maximize the antenna diameter and reduce the number of loop turns (i.e., windings) of the receive antenna 518 and the inter-winding capacitance.

Receive circuitry 510 may provide an impedance match to the receive antenna 518. Receive circuitry 510 includes power conversion circuitry 506 for converting received energy into charging power for use by the device 550. Power conversion circuitry 506 includes an AC-to-DC converter 520 and may also include a DC-to-DC converter 522. AC-to-DC converter 520 rectifies the RF energy signal received at receive antenna 518 into a non-alternating power with an output voltage. The DC-to-DC converter 522 (or other power regulator) converts the rectified energy signal into an energy potential (e.g., voltage) that is compatible with device 550 with an output voltage and output current. Various AC-to-DC converters are contemplated, including partial and full rectifiers, regulators, bridges, doublers, as well as linear and switching converters.

Receive circuitry 510 may further include RX matching and switching circuitry 512 for connecting receive antenna 518 to the power conversion circuitry 506 or alternatively for disconnecting the power conversion circuitry 506. Disconnecting receive antenna 518 from power conversion circuitry 506 not only suspends charging of device 550, but also changes the “load” as “seen” by the transmitter 404 (FIG. 2).

When multiple receivers 508 are present in a transmitter's near-field, it may be desirable to adjust the loading and unloading of one or more receivers to enable other receivers to more efficiently couple to the transmitter. A receiver 508 may also be cloaked in order to eliminate coupling to other nearby receivers or to reduce loading on nearby transmitters. This “unloading” of a receiver is also known herein as a “cloaking.” Furthermore, this switching between unloading and loading controlled by receiver 508 and detected by transmitter 404 may provide a communication mechanism from receiver 508 to transmitter 404. Additionally, a protocol may be associated with the switching that enables the sending of a message from receiver 508 to transmitter 404. By way of example, a switching speed may be on the order of 100 μsec.

In an exemplary embodiment, communication between the transmitter 404 and the receiver 508 may take place either via an “out-of-band” separate communication channel/antenna or via “in-band” communication that may occur via modulation of the field used for power transfer.

Receive circuitry 510 may further include signaling detector and beacon circuitry 514 used to identify received energy fluctuations that may correspond to informational signaling from the transmitter to the receiver. Furthermore, signaling and beacon circuitry 514 may also be used to detect the transmission of a reduced signal energy (i.e., a beacon signal) and to rectify the reduced signal energy into a nominal power for awakening either un-powered or power-depleted circuits within receive circuitry 510 in order to configure receive circuitry 510 for wireless charging.

Receive circuitry 510 further includes controller 516 for coordinating the processes of receiver 508 described herein including the control of RX matching and switching circuitry 512 described herein. It is noted that the controller 516 may also be referred to herein as a processor. Cloaking of receiver 508 may also occur upon the occurrence of other events including detection of an external wired charging source (e.g., wall/USB power) providing charging power to device 550. Controller 516, in addition to controlling the cloaking of the receiver, may also monitor beacon circuitry 514 to determine a beacon state and extract messages sent from the transmitter 404. Controller 516 may also adjust the DC-to-DC converter 522 for improved performance.

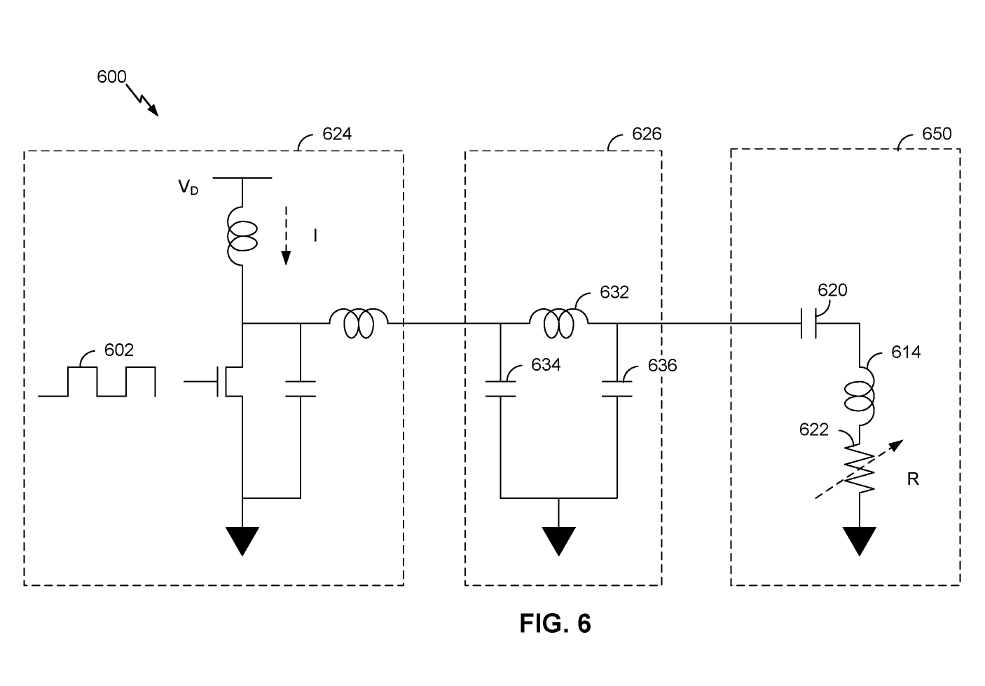

FIG. 6 is a schematic diagram of a portion of transmit circuitry 600 that may be used in the transmit circuitry 406 of FIG. 4. The transmit circuitry 600 may include a driver circuit 624 as described above in FIG. 4. As described above, the driver circuit 624 may be a switching amplifier that may be configured to receive a square wave and output a sine wave to be provided to the transmit circuit 650. In some cases the driver circuit 624 may be referred to as an amplifier circuit. The driver circuit 624 is shown as a class E amplifier; however, any suitable driver circuit 624 may be used in accordance with embodiments of the invention. The driver circuit 624 may be driven by an input signal 602 from an oscillator 423 as shown in FIG. 4. The driver circuit 624 may also be provided with a drive voltage V_{D} that is configured to control the maximum power that may be delivered through a transmit circuit 650. To eliminate or reduce harmonics, the transmit circuitry 600 may include a filter circuit 626. The filter circuit 626 may be a three pole (capacitor 634, inductor 632, and capacitor 636) low pass filter circuit 626.

The signal output by the filter circuit 626 may be provided to a transmit circuit 650 comprising an antenna 614. The transmit circuit 650 may include a series resonant circuit having a capacitance 620 and inductance (e.g., that may be due to the inductance or capacitance of the antenna or to an additional capacitor component) that may resonate at a frequency of the filtered signal provided by the driver circuit 624. The load of the transmit circuit 650 may be represented by the variable resistor 622. The load may be a function of a wireless power receiver 508 that is positioned to receive power from the transmit circuit 650.

In an exemplary embodiment, an auxiliary winding for a wireless power transfer resonator reduces the level of a common-mode signal in the wireless power transfer resonator, and may be suited in particular for single-ended resonator circuits. Wireless charging systems can transfer charge to a charge receiving device by magnetic field coupling or by electric field coupling. A magnetic field coupling is also referred to as an inductive coupling and generally uses what is referred to as an H-field, or B-field, coupling. An electric field coupling is also referred to as capacitive coupling and generally uses what is referred to as an E-field coupling. The auxiliary winding can be incorporated into an antenna or resonator structure that controls both the magnetic field and the electric field.

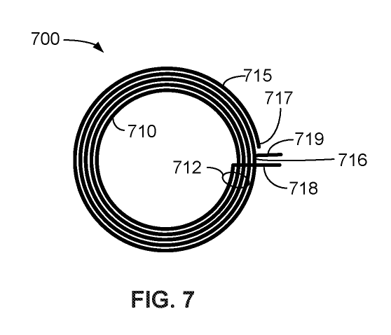

FIG. 7 is a simplified diagram illustrating an exemplary embodiment of an antenna structure 700 that can be used in a wireless power transfer system. In an exemplary embodiment, the antenna structure 700 will be described in the context of a wireless power receiver. However, the antenna structure 700 can also be associated with a wireless power transmitter. While the following description of the exemplary embodiments describes embodiments relative to an antenna that can be configured as part of a circuit for power transfer, the embodiments thereof described herein may also be incorporated into resonant structures configured for resonant power transfer systems as well. In an exemplary embodiment, the antenna structure 700 comprises a wireless power receiver antenna 710 having a primary antenna portion 712 and an auxiliary winding 715. The wireless power receiver antenna 710 may also be referred to as a coil; however, the wireless power receiver antenna 710 need not be circular in shape. In an exemplary embodiment, the auxiliary winding 715 may comprise the same material from which the primary antenna portion 712 is fabricated, or may comprise a material different than the material from which the primary antenna portion 712 is fabricated. In an exemplary embodiment in which the antenna structure is part of a single-ended circuit, the auxiliary winding 715 may be electrically coupled to the ground referenced side of the primary antenna portion 712 at point 716. In an exemplary embodiment, the auxiliary winding 715 may extend around the outside of the primary antenna portion 712 from the point 716 to a point 717 in the same direction in which the primary antenna portion 712 is wound (e.g., along outer edge). In this exemplary embodiment, the auxiliary winding 715 may be referred to as “co-wound” with respect to the primary antenna portion 712. The auxiliary winding 715 may be a fraction of the number of turns of the primary antenna portion 712 or may be a multiple of the number of turns of the primary antenna portion 712.

The antenna structure 700 may be implemented in a wireless power transmitter or a wireless power receiver. If implemented in a wireless power transmitter, a transmit input signal may be applied to the conductor 718 by, for example, the transmit circuitry 406 (FIG. 4) and the conductor 719 may be coupled to a ground reference. If implemented in a wireless power receiver, receive circuitry, such as the receive circuitry 510, may be coupled to the conductor 718 and the conductor 719 may be coupled to a ground reference. The conductors 718 and 719 may also be referred to as terminals.

In an exemplary embodiment, the primary antenna portion 712 generates a primary electric field (E-field) and a primary magnetic field (B-field). The primary magnetic field (B-field) generated by the primary antenna portion 712 induces a voltage (via electromotive force (EMF)) on the auxiliary winding 715. The voltage induced on the auxiliary winding 715 may comprise an EMF induced voltage at the fundamental power transfer frequency, may include an EMF induced voltage at other frequencies, and may include an EMF induced voltage at harmonics of the fundamental power transfer frequency. In an exemplary embodiment, the auxiliary winding 715 does not necessarily carry a current as a result of an applied input signal or a generated output signal, but the voltage induced in the auxiliary winding 715 generates an auxiliary electric field (E-field) in the auxiliary winding 715. The auxiliary electric field (E-field) generated in the auxiliary winding 715 is substantially 180 degrees out of phase with respect to the primary E-field in the primary antenna portion 712 and opposes the primary E-field in the primary antenna portion 712, thereby reducing the net electric (E)-field in the antenna structure 700, and thereby reducing the common-mode signal of the antenna structure 700 including the primary antenna portion 712 and the auxiliary winding 715. When the magnitude of the auxiliary E-field generated in the auxiliary winding 715 is substantially equal to the magnitude of the primary E-field generated by the primary antenna portion 712, then the auxiliary E-field substantially cancels the primary E-field. When the phase of the E-field in the auxiliary winding 715 is substantially 180 degrees out of phase with respect to the phase of the E-field in the primary antenna portion 712, and the magnitude of the auxiliary E-field generated in the auxiliary winding 715 is less than the magnitude of the primary E-field generated by the primary antenna portion 712, then the net E-field in the antenna structure 700 is the difference in magnitude between the magnitude of the primary E-field and the magnitude of the auxiliary E-field.

The reduction in the common mode voltage allows the use of single-ended circuitry, such as, for example, half-bridge rectification circuitry, thus reducing circuit footprint, and component cost, and facilitating miniaturization.

In an alternative exemplary embodiment, the auxiliary winding may be configured as part of a resonant circuit that may carry current. For example, an end of the auxiliary winding may be capacitively coupled in parallel to the primary antenna portion 712, thus forming a parallel resonant circuit that could modify the net impedance of the antenna structure 700. This may be beneficial for modifying the impedance of the resonator but generally degrades the EMI and common-mode cancellation aspect due to a narrowing of operation frequency.

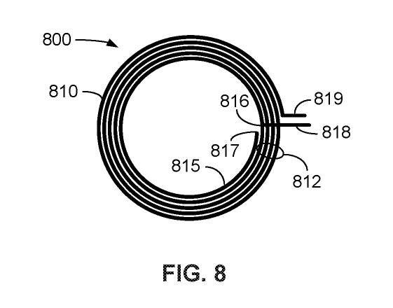

FIG. 8 is a cross-sectional diagram illustrating an exemplary embodiment of an antenna structure 800 that can be used in a wireless power transfer system. In an exemplary embodiment, the antenna structure 800 will be described in the context of a wireless power receiver. However, the antenna structure 800 can also be associated with a wireless power transmitter. While the following description of the exemplary embodiments describes embodiments relative to an antenna that can be configured as part of a circuit for power transfer, the embodiments thereof described herein may also be incorporated into resonant structures configured for resonant power transfer systems as well. In an exemplary embodiment, the antenna structure 800 comprises a wireless power receiver antenna 810 having a primary antenna portion 812 and an auxiliary winding 815. The wireless power receiver antenna 810 may also be referred to as a coil; however, the wireless power receiver antenna 810 need not be circular in shape. In an exemplary embodiment, the auxiliary winding 815 may comprise the same material from which the primary antenna portion 812 is fabricated, or may comprise a material different than the material from which the primary antenna portion 812 is fabricated. In an exemplary embodiment, in which the antenna structure 800 is implemented in a balanced or near-balanced circuit, the auxiliary winding 815 may be electrically coupled to the internal winding side of the primary antenna portion 812 at point 816. A balanced differential circuit or balanced antenna coil geometry generally has equal magnitude and opposite polarity signals (180 degree phase rotation from each other), yielding high common mode signal rejection. A non-symmetrical, or unbalanced, antenna geometry has low common mode signal rejection because the projected E-field is not opposed. Similarly, a symmetrical or well balanced antenna geometry may be coupled to an unbalanced differential circuit, which may have signals that are not equal in magnitude or at substantially opposite phase from each other, exhibiting a relatively high common mode signal. In either case, or a combination of both cases, the embodiments of the auxiliary winding described herein can partially or completely correct for such imbalances, thus reducing the common mode component of the antenna structure by improving the combined geometric and circuit balance.

In an exemplary embodiment, the auxiliary winding 815 may extend around the inside of the primary antenna portion 812 from the point 816 to a point 817 in the same direction in which the primary antenna portion 812 is wound (along an inner edge). In this exemplary embodiment, the auxiliary winding 815 may be referred to as “co-wound” with respect to the primary antenna portion 812. The auxiliary winding 815 may be a fraction of the number of turns of the primary antenna portion 812 or may be a multiple of the number of turns of the primary antenna portion 812.

The antenna structure 800 may be implemented in a wireless power transmitter or a wireless power receiver. If implemented in a wireless power transmitter, a transmit input signal may be applied to the conductors 818 and 819 by, for example, the transmit circuitry 406 (FIG. 4). If implemented in a wireless power receiver, receive circuitry, such as the receive circuitry 510, may be coupled to the conductors 818 and 819. The conductors 818 and 819 may also be referred to as terminals.

In an exemplary embodiment the primary antenna portion 812 generates a primary electric field (E-field) and a primary magnetic field (B-field). The primary magnetic field (B-field) generated by the primary antenna portion 812 induces a voltage (via electromotive force (EMF)) on the auxiliary winding 815. The voltage induced on the auxiliary winding 815 may comprise an EMF induced voltage at the fundamental power transfer frequency, may include an EMF induced voltage at other frequencies, and may include an EMF induced voltage at harmonics of the fundamental power transfer frequency. In an exemplary embodiment, the auxiliary winding 815 does not necessarily carry a current as a result of an applied input signal or a generated output signal, but the voltage induced in the auxiliary winding 815 generates an auxiliary electric field (E-field) in the auxiliary winding 815. The auxiliary electric field (E-field) generated in the auxiliary winding 815 is substantially 180 degrees out of phase with respect to the primary E-field in the primary antenna portion 812 and opposes the primary E-field in the primary antenna portion 812, thereby reducing the net electric (E)-field in the antenna structure 800, and thereby reducing the common-mode signal of the antenna structure 800 including the primary antenna portion 812 and the auxiliary winding 815. When the magnitude of the auxiliary E-field generated in the auxiliary winding 815 is substantially equal to the magnitude of the primary E-field generated by the primary antenna portion 812, then the auxiliary E-field substantially cancels the primary E-field. When the phase of the E-field in the auxiliary winding 815 is substantially 180 degrees out of phase with respect to the phase of the E-field in the primary antenna portion 815, and the magnitude of the auxiliary E-field generated in the auxiliary winding 815 is less than the magnitude of the primary E-field generated by the primary antenna portion 812, then the net E-field in the antenna structure 800 is the difference in magnitude between the magnitude of the primary E-field and the magnitude of the auxiliary E-field. In an exemplary embodiment, the reduction in the common mode voltage improves the performance of a near-balanced differential circuit.

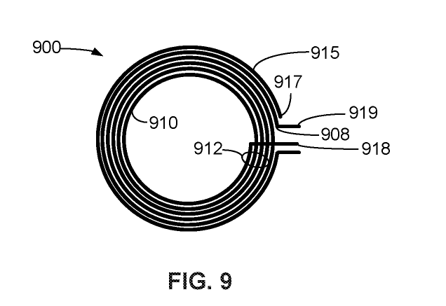

FIG. 9 is a cross-sectional diagram illustrating an exemplary embodiment of an antenna structure 900 that can be used in a wireless power transfer system. In an exemplary embodiment, the antenna structure 900 will be described in the context of a wireless power receiver. However, the antenna structure 900 can also be associated with a wireless power transmitter. While the following description of the exemplary embodiments describes embodiments relative to an antenna that can be configured as part of a circuit for power transfer, the embodiments thereof described herein may also be incorporated into resonant structures configured for resonant power transfer systems as well. In an exemplary embodiment, the antenna structure 900 comprises a wireless power receiver antenna 910 having a primary antenna portion 912 and an auxiliary winding 915. The wireless power receiver antenna 910 may also be referred to as a coil; however, the wireless power receiver antenna 910 need not be circular in shape. In an exemplary embodiment, the auxiliary winding 915 may comprise the same material from which the primary antenna portion 912 is fabricated, or may comprise a material different than the material from which the primary antenna portion 912 is fabricated. In an exemplary embodiment, in which the antenna structure 900 is implemented in a balanced or near-balanced circuit, the auxiliary winding 915 may be located around the outer circumference of the primary antenna portion 912. In an exemplary embodiment, the auxiliary winding 915 may extend around the outside of the primary antenna portion 912 to a point 917 in the opposite direction in which the primary antenna portion 912 is wound. In this exemplary embodiment in which the winding of the primary antenna portion 912 begins at point 908, the auxiliary winding 915 may be referred to as “counter-wound” with respect to the primary antenna portion 912. The auxiliary winding 915 may be a fraction of the number of turns of the primary antenna portion 912 or may be a multiple of the number of turns of the primary antenna portion 912. In an exemplary embodiment, the auxiliary winding 915 may be referred to as an “isolated shield” because it is not directly electrically coupled to the primary antenna portion 912.

The antenna structure 900 may be implemented in a wireless power transmitter or a wireless power receiver. If implemented in a wireless power transmitter, a transmit input signal may be applied to the conductors 918 and 919 by, for example, the transmit circuitry 406 (FIG. 4). If implemented in a wireless power receiver, receive circuitry, such as the receive circuitry 510, may be coupled to the conductors 918 and 919. The conductors 918 and 919 may also be referred to as terminals.

In an exemplary embodiment the primary antenna portion 912 generates a primary electric field (E-field) and a primary magnetic field (B-field). The primary magnetic field (B-field) generated by the primary antenna portion 912 induces a voltage (via electromotive force (EMF)) on the auxiliary winding 915. The voltage induced on the auxiliary winding 915 may comprise an EMF induced voltage at the fundamental power transfer frequency, may include an EMF induced voltage at other frequencies, and may include an EMF induced voltage at harmonics of the fundamental power transfer frequency. In an exemplary embodiment, the auxiliary winding 915 does not necessarily carry a current as a result of an applied input signal or a generated output signal, but the voltage induced in the auxiliary winding 915 generates an auxiliary electric field (E-field) in the auxiliary winding 915. The auxiliary electric field (E-field) generated in the auxiliary winding 915 is substantially 180 degrees out of phase with respect to the primary E-field in the primary antenna portion 912 and opposes the primary E-field from the primary antenna portion 912, thereby reducing the net electric (E)-field in the antenna structure 900, and thereby reducing the common-mode signal of the antenna structure 900 including the primary antenna portion 912 and the auxiliary winding 915. When the magnitude of the auxiliary E-field generated in the auxiliary winding 915 is substantially equal to the magnitude of the primary E-field generated by the primary antenna portion 912, then the auxiliary E-field substantially cancels the primary E-field. When the phase of the E-field in the auxiliary winding 915 is substantially 180 degrees out of phase with respect to the phase of the E-field in the primary antenna portion 915, and the magnitude of the auxiliary E-field generated in the auxiliary winding 915 is less than the magnitude of the primary E-field generated by the primary antenna portion 912, then the net E-field in the antenna structure 900 is the difference in magnitude between the magnitude of the primary E-field and the magnitude of the auxiliary E-field. In an exemplary embodiment, the reduction in the common mode voltage improves the performance of a near-balanced differential circuit.

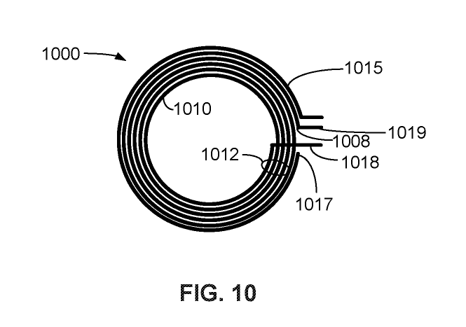

FIG. 10 is a cross-sectional diagram illustrating an exemplary embodiment of an antenna structure 1000 that can be used in a wireless power transfer system. In an exemplary embodiment, the antenna structure 1000 will be described in the context of a wireless power receiver. However, the antenna structure 1000 can also be associated with a wireless power transmitter. While the following description of the exemplary embodiments describes embodiments relative to an antenna that can be configured as part of a circuit for power transfer, the embodiments thereof described herein may also be incorporated into resonant structures configured for resonant power transfer systems as well. In an exemplary embodiment, the antenna structure 1000 comprises a wireless power receiver antenna 1010 having a primary antenna portion 1012 and an auxiliary winding 1015. The wireless power receiver antenna 1010 may also be referred to as a coil. In an exemplary embodiment, the auxiliary winding 1015 may comprise the same material from which the primary antenna portion 1012 is fabricated, or may comprise a material different than the material from which the primary antenna portion 1012 is fabricated. In an exemplary embodiment in which the antenna structure 1000 is implemented in a balanced or near-balanced circuit, the auxiliary winding 1015 may be located around the outer circumference of the primary antenna portion 1012.

In an exemplary embodiment, the auxiliary winding 1015 may extend around the outside of the primary antenna portion 1012 to point 1017 in the same direction in which the primary antenna portion 1012 is wound. In this exemplary embodiment in which the winding of the primary antenna portion 1012 begins at point 1008, the auxiliary winding 1015 may be referred to as “co-wound” with respect to the primary antenna portion 1012. The auxiliary winding 1015 may be a fraction of the number of turns of the primary antenna portion 1012 or may be a multiple of the number of turns of the primary antenna portion 1012. In an exemplary embodiment, the auxiliary winding 1015 may be referred to as an “isolated shield” because it is not directly electrically coupled to the primary antenna portion 1012.

The antenna structure 1000 may be implemented in a wireless power transmitter or a wireless power receiver. If implemented in a wireless power transmitter, a transmit input signal may be applied to the conductors 1018 and 1019 by, for example, the transmit circuitry 406 (FIG. 4). If implemented in a wireless power receiver, receive circuitry, such as the receive circuitry 510, may be coupled to the conductor s1018 and 1019. The conductors 1018 and 1019 may also be referred to as terminals.

In an exemplary embodiment the primary antenna portion 1012 generates a primary electric field (E-field) and a primary magnetic field (B-field). The primary magnetic field (B-field) generated by the primary antenna portion 1012 induces a voltage (via electromotive force (EMF)) on the auxiliary winding 1015. The voltage induced on the auxiliary winding 1015 may comprise an EMF induced voltage at the fundamental power transfer frequency, may include an EMF induced voltage at other frequencies, and may include an EMF induced voltage at harmonics of the fundamental power transfer frequency. The auxiliary winding 1015 does not necessarily carry a current as a result of an applied input signal or a generated output signal, but the voltage induced in the auxiliary winding 1015 generates an auxiliary electric field (E-field) in the auxiliary winding 1015. The auxiliary electric field (E-field) generated in the auxiliary winding 1015 is substantially 180 degrees out of phase with respect to the primary E-field in the primary antenna portion 1012 and opposes the primary E-field in the primary antenna portion 1012, thereby reducing the net electric (E)-field in the antenna structure 1000, and thereby reducing the common-mode signal of the antenna structure 1000 including the primary antenna portion 1012 and the auxiliary winding 1015. When the magnitude of the auxiliary E-field generated in the auxiliary winding 1015 is substantially equal to the magnitude of the primary E-field generated by the primary antenna portion 1012, then the auxiliary E-field substantially cancels the primary E-field. When the phase of the E-field in the auxiliary winding 1015 is substantially 180 degrees out of phase with respect to the phase of the E-field in the primary antenna portion 1015, and the magnitude of the auxiliary E-field generated in the auxiliary winding 1015 is less than the magnitude of the primary E-field generated by the primary antenna portion 1012, then the net E-field in the antenna structure 1000 is the difference in magnitude between the magnitude of the primary E-field and the magnitude of the auxiliary E-field. In an exemplary embodiment, the reduction in the common mode voltage improves the performance of a near-balanced differential circuit.

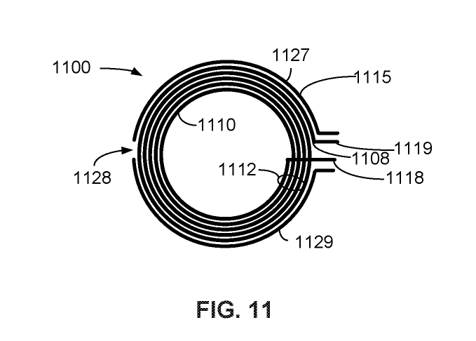

FIG. 11 is a cross-sectional diagram illustrating an exemplary embodiment of an antenna structure 1100 that can be used in a wireless power transfer system. In an exemplary embodiment, the antenna structure 1100 will be described in the context of a wireless power receiver. However, the antenna structure 1100 can also be associated with a wireless power transmitter. While the following description of the exemplary embodiments describes embodiments relative to an antenna that can be configured as part of a circuit for power transfer, the embodiments thereof described herein may also be incorporated into resonant structures configured for resonant power transfer systems as well. In an exemplary embodiment, the antenna structure 1100 comprises a wireless power receiver antenna 1110 having a primary antenna portion 1112 and an auxiliary winding 1115. The wireless power receiver antenna 1110 may also be referred to as a coil. In an exemplary embodiment, the auxiliary winding 1115 may comprise the same material from which the primary antenna portion 1112 is fabricated, or may comprise a material different than the material from which the primary antenna portion 1112 is fabricated.

In an exemplary embodiment in which the antenna structure 1100 is implemented in a balanced or near-balanced circuit, the auxiliary winding 1115 may comprise a first portion 1127 that is located around the outer circumference of the primary antenna portion 1112 and a second portion 1129 that is located around the outer circumference of the primary antenna portion 1112. The first portion 1127 and the second portion 1129 extend around the outside of the primary antenna portion 1112 in opposite directions, and leave a gap or split 1128. In an exemplary embodiment in which the winding of the primary antenna portion 1112 begins at point 1108, the first portion 1127 may be referred to as “co-wound” with respect to the primary antenna portion 1112 and the second portion 1129 may be referred to as “counter-wound” with respect to the primary antenna portion 1112. In an exemplary embodiment, the auxiliary winding 1115 may be referred to as a “split shield” because the first portion 1127 generally extends from the conductor 1119 of the primary antenna portion 1112 and the second portion 1129 generally extends from the conductor 1118 of the primary antenna portion 1112, where the first portion 1127 and the second portion 1129 extend around the periphery of the primary antenna portion 1112 leaving the gap 1128. In an exemplary embodiment, the gap 1128 may be located substantially opposite the conductors 1118 and 1119 as shown in FIG. 11. However, the gap 1128 may be located in other locations around the periphery of the antenna structure 1100 such that the respective lengths of the first portion 1127 and the second portion 1129 differ.

The antenna structure 1100 may be implemented in a wireless power transmitter or a wireless power receiver. If implemented in a wireless power transmitter, a transmit input signal may be applied to the conductors 1118 and 1119 by, for example, the transmit circuitry 406 (FIG. 4). If implemented in a wireless power receiver, receive circuitry, such as the receive circuitry 510, may be coupled to the conductor 1118 and the conductor 1119 may be coupled to a ground reference. The conductors 1118 and 1119 may also be referred to as terminals.

In an exemplary embodiment the primary antenna portion 1112 generates a primary electric field (E-field) and a primary magnetic field (B-field). The primary magnetic field (B-field) generated by the primary antenna portion 1112 induces a voltage (via electromotive force (EMF)) on the auxiliary winding 1115. The voltage induced on the auxiliary winding 1115 may comprise an EMF induced voltage at the fundamental power transfer frequency, may include an EMF induced voltage at other frequencies, and may include an EMF induced voltage at harmonics of the fundamental power transfer frequency. The auxiliary winding 1115 does not necessarily carry a current as a result of an applied input signal or a generated output signal, but the voltage induced in the auxiliary winding 1115 generates an auxiliary electric field (E-field) in the auxiliary winding 1115. The auxiliary electric field (E-field) generated in the auxiliary winding 1115 is substantially 180 degrees out of phase with respect to the primary E-field in the primary antenna portion 1112 and opposes the primary E-field in the primary antenna portion 1112, thereby reducing the net electric (E)-field in the antenna structure 1100, and thereby reducing the common-mode signal of the antenna structure 1100 including the primary antenna portion 1112 and the auxiliary winding 1115. When the magnitude of the auxiliary E-field generated in the auxiliary winding 1115 is substantially equal to the magnitude of the primary E-field generated by the primary antenna portion 1112, then the auxiliary E-field substantially cancels the primary E-field. When the phase of the E-field in the auxiliary winding 1115 is substantially 180 degrees out of phase with respect to the phase of the E-field in the primary antenna portion 1115, and the magnitude of the auxiliary E-field generated in the auxiliary winding 1115 is less than the magnitude of the primary E-field generated by the primary antenna portion 1112, then the net E-field in the antenna structure 1100 is the difference in magnitude between the magnitude of the primary E-field and the magnitude of the auxiliary E-field. In an exemplary embodiment, the reduction in the common mode voltage improves the performance of a near-balanced differential circuit.

In an exemplary embodiment, the auxiliary winding 1115 develops a substantially balanced electro-motive force (EMF), i.e., an induced voltage, symmetrically on both the first portion 1127 and the second portion 1129. The auxiliary winding 1115 reduces the exposed EMF and the balanced nature of the auxiliary winding 1115 cancels a significant portion of the common mode signal in the primary antenna portion 1112. Moreover, in an exemplary embodiment where the auxiliary winding 1115 may not develop a completely balanced EMF, but may develop an EMF lower than an EMF developed by the primary antenna portion 1112, the auxiliary winding 1115 still reduces electromagnetic interference emissions from the primary antenna portion 1112.

The gap 1128 in the auxiliary winding 1115 prevents current from being developed in the auxiliary winding 1115 and attenuates a substantial portion of the electric field in the primary antenna portion 1112, thus attenuating EMI radiating from the coil.

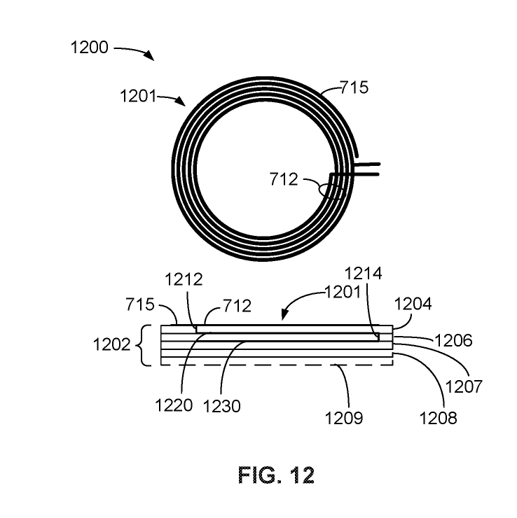

FIG. 12 is a simplified diagram illustrating an exemplary embodiment of a multi-layer antenna structure 1200 that can be used in a wireless power transfer system. In an exemplary embodiment, the multi-layer antenna structure 1200 may comprise a multi-layer structure 1202. In an exemplary embodiment, the multi-layer structure 1202 may comprise at least a part of a printed circuit board (PCB) or other multi-layer structure on which embodiments of the antenna structures described herein may be located. In an exemplary embodiment, the multi-layer structure 1202 may comprise three exemplary layers 1204, 1206 and 1207 on which portions of a wireless power antenna may be located. The three exemplary layers 1204, 1206 and 1207 may be located over an optional ferrite layer 1208. The optional ferrite layer 1208 may be located over an optional ground plane 1209. In an exemplary embodiment, the ground plane 1209 may comprise a ground layer and may also comprise circuitry (not shown) that can be coupled to an antenna structure 1201. In an exemplary embodiment, the antenna structure 1201 may comprise the antenna structure 700 (FIG. 7) having the primary antenna portion 712 and the auxiliary winding 715 located on a first layer, and may comprise additional antenna portions on additional layers.

In an exemplary embodiment, the layers 1204, 1206 and 1207 may comprise some or all of the antenna structure 1201. While three exemplary layers 1204, 1206 and 1207 are illustrated in FIG. 12 as comprising the antenna structure 1201, the multi-layer structure 1202 may have more or fewer layers.

In an exemplary embodiment, the ferrite layer 1208 and the ground plane 1209 are optional. If they are not present then one or more auxiliary windings may be located on both the top layer 1204 and the bottom layer 1207.

In an exemplary embodiment, the antenna structure 700 of FIG. 7, including the auxiliary winding 715, is illustrated as being located on the upper layer 1204. Additional primary windings may be electrically coupled to the antenna structure 700, forming the antenna structure 1201. For example, a via 1212 may be used to couple an additional primary antenna winding 1220 to the primary antenna portion 712 and a via 1214 may be used to couple an additional primary antenna winding 1230 to the additional primary antenna winding 1220. In such an embodiment, the antenna structure 1201 may comprise the antenna structure 700 and additional windings 1220 and 1230 coupled in series to the primary antenna portion 712.

In an exemplary embodiment, the additional primary antenna winding 1220 can be coupled in series to the primary antenna portion 712 and the additional primary antenna winding 1230 can be coupled in series to the additional primary antenna winding 1220. In an exemplary embodiment, the additional winding 1220 is shown as being located on the layer 1206 and the additional winding 1230 is shown as being located on the layer 1207.

In a multi-layer embodiment, only the outer layers, for example, the layer 1204 when there is a ferrite layer 1208 and a ground plane 1209 present, projects an E-field. The inner layers 1206 and 1207 in this example, are sandwiched by the outer layers and therefore are not externally exposed. In such an embodiment, the outer layer 1204 and the ferrite layer 1208 and ground plane 1209 act as a shield for the inner layers 1206 and 1207. In such an exemplary embodiment, the auxiliary winding 715 is located on an outer layer, such as the layer 1204, thus compensating for the E field generated by the primary antenna portion 712 that is also on the outer layer 1204.

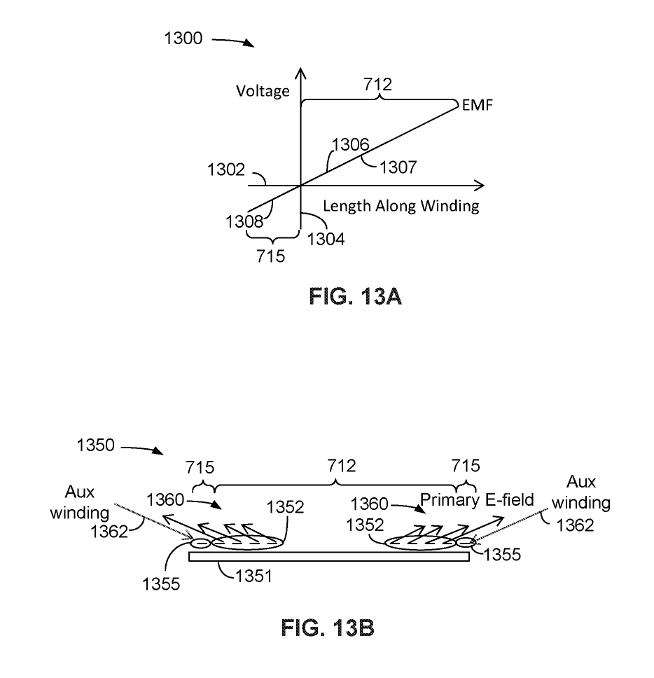

FIG. 13A is a graphical illustration 1300 showing exemplary electromotive force (EMF) generated in an exemplary primary antenna portion and an exemplary auxiliary winding described herein. For ease of illustration, FIG. 13A and FIG. 13B will refer to the primary antenna portion 712 and the auxiliary winding 715 of FIG. 7. However, any of the embodiments of the antennas described herein will have exemplary EMF similar to that shown in FIGS. 13A and 13B. The horizontal axis 1302 represents the length of the winding that comprises the wireless power receiver antenna 710, which includes the primary antenna portion 712 and the auxiliary winding 715. In an exemplary. The vertical axis 1304 represents the EMF as a voltage. The curve 1306 shows an exemplary EMF induced voltage generated by the primary antenna portion 712 and the auxiliary winding 715. The portion 1307 of the curve 1306 shows the EMF induced voltage generated by the primary antenna portion 712 and may be referred to as a primary electric field (E-field). The portion 1308 of the curve 1306 shows the EMF induced voltage generated by the auxiliary winding 715 and may be referred to as an auxiliary electric field (E-field). In an exemplary embodiment, the EMF induced voltage generated by the primary antenna portion 712 is illustrated as being positive in that it is located in quadrant 1 of the graphical illustration 1300 and the EMF induced voltage generated by the auxiliary winding 715 is illustrated as being negative in that it is located in quadrant 3 of the graphical illustration 1300. In an exemplary embodiment, the EMF induced voltage generated by the auxiliary winding 715 generates an auxiliary electric field (E-field) that opposes the primary electric field (E-field), which corresponds to the EMF induced voltage generated by the primary antenna portion 712.

FIG. 13B is a graphical illustration 1350 showing an exemplary embodiment of the effect that an auxiliary winding has on the projected E-field of a primary antenna portion of FIG. 13A. In an exemplary embodiment, the primary antenna portion 712 is depicted on the diagram 1350 using reference numeral 1352 and the auxiliary winding 715 is depicted on the diagram 1350 using reference numeral 1355. A ground plane 1351 may be located adjacent the primary antenna portion 712 and the auxiliary winding 715. The primary E-Field 1360 developed by the primary antenna portion 712 is opposed by the auxiliary E-field 1362 generated by the auxiliary winding 1355 such that the auxiliary E-field 1362 generated by the auxiliary winding 715 reduces the primary E-Field 1360, thereby reducing the net electric (E)-field in the antenna structure 700, and thus reducing the common-mode signal of the antenna structure 700 including the primary antenna portion 712 and the auxiliary winding 715.

In an exemplary embodiment, the outer turn represented by the auxiliary winding 1355 projects a stronger E-field when the antenna structure 700 is used in conjunction with the ground plane 1351 that is located behind the primary antenna portion 712 and the auxiliary winding 715. In such an implementation, there is also generally a ferrite layer (not shown in FIG. 13B) located between the combination of the primary antenna portion 712 and the auxiliary winding 715 and the ground plane 1351. The ferrite layer (not shown) acts to convey the B-field, such that the E-field from the outer winding (the auxiliary winding 1355 in FIG. 13B), is most dominant in the far field. In such a case, an auxiliary winding having a single or partial outer turn can significantly modify the far field projection of the E field.

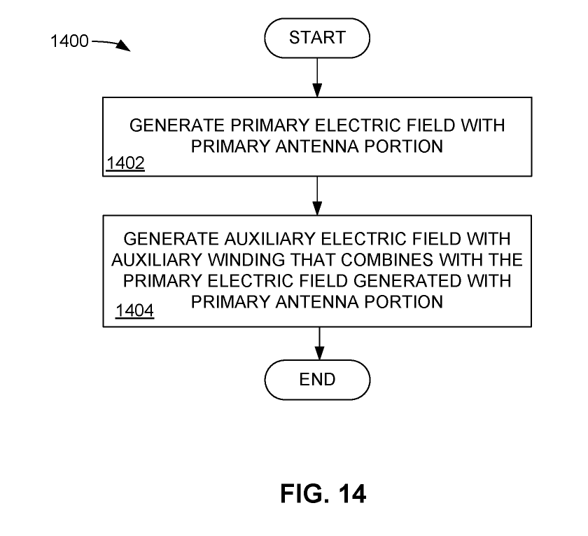

FIG. 14 is a flowchart illustrating an exemplary embodiment of a method 1400 for wireless power transfer. The blocks in the method 1400 can be performed in or out of the order shown. The description of the method 1400 will relate to the various embodiments described herein.

In block 1402, a primary electric field is generated by a primary antenna portion of a wireless power transfer antenna.

In block 1404, an auxiliary electric field is generated by an auxiliary winding. The auxiliary electric field combines with the primary electric field generated by the primary antenna portion of the wireless power transfer antenna resulting in a net electric field that has a magnitude that is smaller than the magnitude of the primary electric field. In an exemplary embodiment in which the auxiliary electric field is substantially 180 out of phase with respect to the primary electric field and is equal in magnitude to the primary electric field, the auxiliary electric field substantially cancels the primary electric field generated by the primary antenna portion of the wireless power transfer antenna, resulting in a net zero electric field.

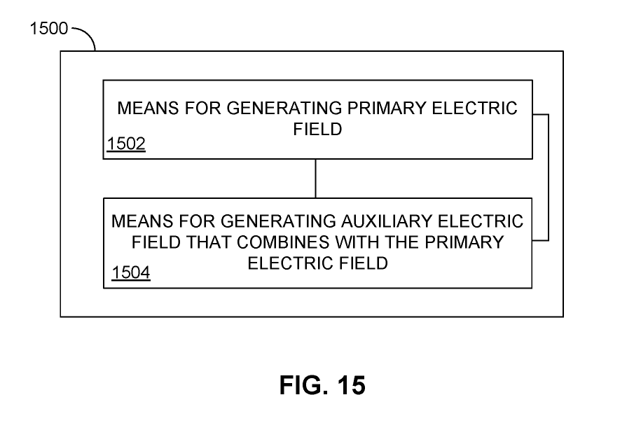

FIG. 15 is a functional block diagram of an apparatus 1500 for wireless power transfer.

The apparatus 1500 comprises means 1502 for generating a primary electric field. In certain embodiments, the means 1502 for generating a primary electric field can be configured to perform one or more of the function described in operation block 1402 of method 1400 (FIG. 14). In an exemplary embodiment, the means 1502 for generating a primary electric field may comprise the primary antenna portions described herein.

The apparatus 1500 further comprises means 1504 for generating an auxiliary electric field that combines with the primary electric field resulting in a net electric field that has a magnitude that is smaller than the magnitude of the primary electric field. In certain embodiments, the means 1504 for generating an auxiliary electric field that reduces the primary electric field can be configured to perform one or more of the function described in operation block 1404 of method 1400 (FIG. 14). In an exemplary embodiment in which the auxiliary electric field is substantially 180 out of phase with respect to the primary electric field and is equal in magnitude to the primary electric field, the means 1504 for generating an auxiliary electric field that combines with the primary electric field may comprise the auxiliary windings described herein, and may comprise an auxiliary electric field that substantially cancels the primary electric field.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

1. A wireless power transfer antenna, comprising:
a primary antenna portion configured to develop a primary electric field (E-field) and a primary magnetic field (B-field); and
an auxiliary winding coupled to the primary antenna portion by the primary B-field, the auxiliary winding configured to develop an auxiliary electric field (E-field) that combines with the primary E-field resulting in a net E-field that has a magnitude that is smaller than a magnitude of the primary E-field.

2. The wireless power transfer antenna of claim 1, wherein the auxiliary E-field generated in the auxiliary winding reduces a common-mode signal on the primary antenna portion and the auxiliary winding.

3. The wireless power transfer antenna of claim 1, wherein the auxiliary E-field is generated by a voltage induced on the auxiliary winding comprising any of an electromotive force (EMF) at a fundamental power transfer frequency, an EMF at other frequencies, and an EMF at harmonics of a fundamental power transfer frequency.

4. The wireless power transfer antenna of claim 1, wherein the primary antenna portion comprises at least one signal input and the auxiliary winding extends from the signal input of the primary antenna portion.

5. The wireless power transfer antenna of claim 1, wherein the primary antenna portion comprises at least one signal ground and the auxiliary winding extends from the signal ground of the primary antenna portion.

6. The wireless power transfer antenna of claim 1, wherein the auxiliary winding is a fraction of a number of turns of the primary antenna portion.

7. The wireless power transfer antenna of claim 1, wherein the auxiliary winding is a multiple of a number of turns of the primary antenna portion.

8. The wireless power transfer antenna of claim 1, wherein the primary antenna portion comprises a single-ended structure having a signal terminal coupled to an electrical signal and a ground referenced terminal coupled to a ground reference.

9. The wireless power transfer antenna of claim 1, wherein the auxiliary winding comprises a shield that extends from a signal input of the primary antenna portion.

10. The wireless power transfer antenna of claim 1, wherein the auxiliary winding comprises a shield that extends from a ground of the primary antenna portion.

11. The wireless power transfer antenna of claim 1, wherein the auxiliary winding comprises a shield having a first portion that extends from a first signal input of the primary antenna portion and a second portion that extends from a second signal input of the primary antenna portion.

12. The wireless power transfer antenna of claim 1, wherein the auxiliary winding carries substantially no electrical current.

13. The wireless power transfer antenna of claim 1, wherein the auxiliary winding carries an electrical current resulting from an applied input signal.

14. The wireless power transfer antenna of claim 1, wherein the auxiliary E-field generated in the auxiliary winding combines with the primary E-field generated in the primary antenna portion resulting in a net zero E-field.

15. The wireless power transfer antenna of claim 1, wherein the primary antenna portion is located in a wireless power receiver that is configured to provide a current to power or charge a load.

16. The wireless power transfer antenna of claim 1, wherein the auxiliary winding is located along an outer edge of the primary antenna portion.

17. The wireless power transfer antenna of claim 1, wherein the auxiliary winding is located along an inner edge of the primary antenna portion.

18. An antenna structure, comprising:
a primary antenna portion configured to develop a primary electric field (E-field) and a primary magnetic field (B-field); and
an auxiliary winding coupled to the primary antenna portion by the primary B-field, the auxiliary winding configured to develop an auxiliary electric field (E-field) that combines with the primary E-field, thereby reducing a net electric (E)-field in the antenna structure, and thereby reducing a common-mode signal in the antenna structure.

19. The antenna structure of claim 18, wherein a magnitude of the primary E-field is substantially equal to a magnitude of the auxiliary E-field and the primary E-field is substantially 180 degrees out of phase with respect to the auxiliary E-field, such that the auxiliary E-field substantially cancels a portion the primary E-field.

20. The antenna structure of claim 18, wherein the auxiliary E-field is generated by a voltage induced on the auxiliary winding comprising any of an electromotive force (EMF) at a fundamental power transfer frequency, an EMF at other frequencies, and an EMF at harmonics of a fundamental power transfer frequency.

21. The antenna structure of claim 18, wherein the primary antenna portion comprises at least one signal input and at least one signal ground and the auxiliary winding extends from one of the signal input of the primary antenna portion and the signal ground of the primary antenna portion.

22. The antenna structure of claim 18, wherein the auxiliary winding is one of a fraction of a number of turns of the primary antenna portion and a multiple of a number of turns of the primary antenna portion.

23. The antenna structure of claim 18, wherein the primary antenna portion comprises a single-ended structure having a signal terminal coupled to an electrical signal and a ground referenced terminal coupled to a ground reference.

24. The antenna structure of claim 18, wherein the auxiliary winding comprises a shield that extends from one of a signal input of the primary antenna portion and a ground of the primary antenna portion.

25. The antenna structure of claim 18, wherein the auxiliary winding comprises a shield having a first portion that extends from a first signal input of the primary antenna portion and a second portion that extends from a second signal input of the primary antenna portion.

26. The antenna structure of claim 18, wherein the primary antenna portion is located in a wireless power receiver that is configured to provide a current to power or charge a load.

27. A method for wireless power transfer, comprising:
generating a primary electric field (E-field) and a primary magnetic field (B-field); and
generating an auxiliary electric field (E-field) based on the primary B-field, the auxiliary e-field combining with the primary E-field such that a net E-field comprising the primary E-field and the auxiliary E-field has a magnitude that is smaller than a magnitude of the primary E-field.

28. The method of claim 27, wherein a magnitude of the primary E-field is substantially equal to a magnitude of the auxiliary E-field and the primary E-field is substantially 180 degrees out of phase with respect to the auxiliary E-field, such that the auxiliary E-field substantially cancels a portion of the primary E-field.

29. A device for wireless power transfer, comprising:
means for generating a primary electric field (E-field) and a primary magnetic field (B-field); and
means for generating an auxiliary electric field (E-field) based on the primary B-field, the auxiliary e-field combining with the primary E-field such that a net E-field comprising the primary E-field and the auxiliary E-field has a magnitude that is smaller than a magnitude of the primary E-field.

30. The device of claim 29, wherein a magnitude of the primary E-field is substantially equal to a magnitude of the auxiliary E-field and the primary E-field is substantially 180 degrees out of phase with respect to the auxiliary E-field and the means for generating an auxiliary E-field comprise means for substantially canceling a portion the primary E-field.
